(19) United States
(12) Patent Application Publication
(10) Pub. No.: US 2006/0269710 A1
(43) Pub. Date: Nov. 30, 2006

(54) Film and sheet for folding packaging containers

(76) Inventor: Thomas L. Inglis, Wingham (CA)

Correspondence Address: Dennison Associates;Suite 301, 133 Richmond Street West, Toronto, ON, M5H 2L7, CA

(21) Appl. No.: 11/442,441

(22) Filed: May 30, 2006

(30) Foreign Application Priority Data
May 30, 2005 (CA) 2,508,859

(51) Int. Cl. B32B 27/08

(52) U.S. Cl. 428/35.7

(57) ABSTRACT

A film of biodegradable polylactic acid polymers (PLA) and copolymers are produced by biaxially orienting single and multilayer extrusions. The film and sheets are stiff, have excellent optical properties and show excellent retained folding and creasing properties making them especially desirable for the production of folded box like containers. The surface layer(s) of the film and sheet may be heat sealable or modified with a particle to give improved coefficient of friction (COF), blocking resistance, reduced static generation, improved winding and improved package formation on packaging machines.

### FIELD OF THE INVENTION

This invention relates to the production and use of oriented multilayered biodegradable films with improved dead fold, crease retention, a hinging action, excellent optical properties, coefficient of friction (COF), flavor and aroma barrier and reduced blocking and static generation. In particular it relates to multilayered biodegradable mono or biaxially oriented polylactic acid films and sheets for use in packaging articles in die cut and folded containers or tubular containers or with formed and hinged clam shell packaging, or as lid stock and the like. The films are heat and ultrasonic and solvent sealable.

### DESCRIPTION OF THE RELATED ART

High quality products such as perfume, liquors, jewelry, confectionary products, and the like are beneficially displayed in high clarity box like containers consisting of folded polymers, tubular containers or clam shell hinged containers which have replaced highly printed paperboard containers. However, existing polymers such as PVC, polystyrene and polyolefins when used to replace the paperboard containers give up the composting behavior of the paper board and are considered by some to be less desirable environmentally. This is especially true when the high clarity replacement is produced form chlorine containing polymers such as polyvinyl chloride (PVC), polyvinylidene chloride (PVDC) or their copolymers. In some locations the use of these high clarity chlorinated packaging materials are not legally permitted, severely limiting the choice of alternatives for high clarity folding containers. In addition many of the alternative materials such as styrene based materials are brittle and require heat for folding and the fold is not extremely durable and therefore, unsuitable as a hinge requiring a large amount of flexing as in opening and closing of the container. Also if the more flexible polymers are chosen, they generally have poorer optical properties and stiffness such as the propylene based materials. Other materials, if modified to make them flexible and more durable, have the tendency to stress whiten when bent, creased or flexed due to the toughing mechanisms of the polymers. These problems are readily over come by the use of a multilayer, oriented polylactic acid film or sheet ranging from 4 to 25 mils in thickness.

Polylactic acid is a biodegradable or compostable polymer produced from the condensation polymerization of lactic acid. The monomer used for the production of polylactic acid is available in two optically active isomers, the D-Lactic acid and the L-lactic acid. The relative amounts of the two isomers when combined together and polymerized yield various polymers with different crystallinity (amorphous to semicryatalline), crystallization behavior and melting points. Polymers of this type are available from Cargill-Dow and are represented by the commercial polymer grades, PLA4042 and PLA4060. Both resins are produced by the combination of the two optical isomers of lactic acid, the L-lactic acid and the D-lactic acid in different ratios. The relative ratio of the two isomers controls the final crystallinity and crystallization behavior of the polymers which result in polymers with varying physical and thermal properties.

When the commercially available polylactic acid polymers (PLA) are coextruded and biaxially stretched, the films produced have excellent dead fold, fold durability when flexed, optical clarity and gloss. When the films and sheets are in the thickness range of 4 mils to 25 mils they display an excellent folding property where a scored or unscored bend, crease or fold is made. The folded film or sheets are both durable and flexible displaying a hinge like action on multiple folding and a permanent fold which readily holds it position when flexed. In addition, the fold shows little or no voiding or “stress whitening” typical of other toughened polymers used in these applications. These properties makes it especially attractive for the manufacture of high clarity folded display cartons such as are currently manufactured with PVC, amorphous polyester, polypropylene, polypropylene copolymers, polystyrene and impact modified polystyrene and the like. The film and sheet is especially suitable for replacing existing clear box materials with an improved folding performance as well as for replacing card board or paper products in tubular or clam shell containers where the clarity of the new film or sheet is desired and the composting ability of the polylactic acid does not detract from the environmental concerns of the paper board replacement with the polymers.

U.S. Pat. No. 4,447,479 discloses packaging applications using polypropylene based products.

U.S. Pat. No. 6,743,490 B2 discloses a lamination of a PLA film to a thick paper and relates to a packaging box for a golf ball, and more particularly to a packaging box which can be decomposed completely when it is disposed into the ground in consideration of environmental protection, looks fine, and is not damaged easily to allow the packaging box to have a high function. The packaging box makes use of a combination of thick paper and PLA films where the PLA film is used to give a folded window in the box while the majority of the container is opaque due to the presence of the paper laminated to the film. The PLA film is biaxially oriented.

The use of slip modified outer layers also permit the slip modification of the PLA films and sheets to improve the performance of unmodified or single layer PLA films or sheets. In general unmodified PLA films or sheets demonstrate poor surface slip properties as defined by the coefficient of friction (COF) and result in poor film roll quality and in poor registration and stacking in cut and stack applications and as a result are prone to surface scratching when processed or when passed over stationary equipment parts as found on converting and packaging machines. In addition excessive forces are required to pull film products through the packaging machines leading to film breakage wrinkles and creases. In addition thin films produced with skins of unmodified lower crystallinity PLA 4060 show a pronounced tendency to block in roll or stack form especially when surface treated such as by corona, flame or plasma treatment methods common in the film industry. Aside form the blocking the formation of well formed rolls both in winding on the orienter and in rewinding and slitting is very difficult. This tendency towards poor roll formation and blocking leads to excessive film loss and poor manufacturing efficiencies especially with thin PLA films below 4 mils in thickness. However, it has been observed that three layer coextruded films produced above 4 mils and especially above 7 mils using the high crystallinity PLA4042 resin and without slip modification can be used without too much trouble.

The use of antiblock particles to improve film performance is widely known and in the case of single layer films the incorporation of additives must be in the entire thickness of the polymer. This has several disadvantages in that the antiblock particles are surface agents designed to control the contact area of two adjacent film layers or between the film surface and adjacent surfaces such as metal or rubber covered rollers on processing equipment and therefore the benefit of a large portion of the particles are lost due to their incorporation in the inside of the film away from the surface. Therefore larger quantities of antiblocking particles must be used than are required for the improvement in surface properties. This results in an increased cost for the antiblock particles and will limit the use of expensive but highly effective additives such as the spherical crosslinked silicones such as Tospearl or crosslinked acrylic spheres such as Epostar. In addition, the use of additional non functional particles in the core will increase the amount of light scattering as measured as the film haze and reduce the value and aesthetic appeal of the film as it impacts the ability to display the packaged product.

There still remains a need for multilayer coextruded films or sheet comprised of biodegradable polylactic acid copolymers with improved folding, creasing and folded hinge durability, excellent optical clarity and are of high gloss while displaying improved COF and scuff resistance when wound or cut and stacked as sheets.

### SUMMARY OF THE INVENTION

The invention is related to the production of multilayer coextruded films or sheet of from 4 to 30 mils thick comprised of various commercially available biodegradable polylactic acid copolymers with improved folding, creasing and folded hinge durability. The films also display an excellent optical clarity and are of high gloss while displaying improved COF and scuff resistance when wound or cut and stacked as sheets.

The films and sheets are of high clarity and gloss and are scuff resistant, stiff and durable and may be die cut, folded and sealed, welded or glued into containers for a range of products. The boxes produced may contain flap type openings with a hinge like fold for easy entry and reclosing of the container for ready access to the product. In addition the films and sheets my be thermoformed and folded to produce clam shell containers with a well formed and durable hinge suitable for multiple opening and reclosing.

### DESCRIPTION OF THE INVENTION

The present invention provides for a PLA film which is relatively thick (4 to 30 mils), biaxially oriented and may be coextruded with identical skin and core polymers (equivalent to a monolayer film or sheet), or with heat sealable skins to aid in the sealing of the container by adhesive, ultrasonic, solvent or thermal welding as well as having slip modified surfaces to improve the handling and scuff resistance of the container while maintaining high clarity and gloss of the unmodified film and sheet. The film and sheet products may be wound into rolls or sheeted and may be used in die-cutting and folding applications as well as in the production of tubular containers and for thermoforming applications to produce clam shell containers with hinged lids. The films of the present application provide packaging and other products which do not require the lamination to a relatively thick paper and are used alone without lamination simplifying the manufacture of the packaging.

The present application also provides for the production of multilayer films where surface active antiblock particles can be added to the surface layers alone and which place the particles where they are most useful while reducing significantly the amount of additive required lowering the cost of the film. In addition the total haze of the film may be significantly reduced due to the lower light scattering induced by the absence of scattering particles from the core.

The use of lower melting surface copolymers of polylactic acid permit the containers to be edge sealed or glued or welded as in paper board carton manufacture. The PLA film and sheet surfaces can be adhered to themselves or to the inside and outside layers of the film or sheet by adhesive, heat or ultrasonic and solvent welding to produce high strength bonds to form a high strength container. Single layer films are readily sealed with ultrasonic and solvent welding methods. The sealing method used can be selected to produce a high clarity seals if so desired.

The invention is a coextruded, biodegradable film comprising a core layer of polylactic acid copolymer and at least one additional layer and as many as four additional layers of polylactic acid copolymer of the same or lower melting point from that of the core, and preferably a three layer film or sheet of from 4 to 30 mils in thickness. In addition the films may also be slip modified such that to at least one of the outermost skin layer may be added an antiblock particle generally known in the art such as a spherical particle produced from crosslinked polymethylsilsesquioxane with a particle size ranging from 2 to 10 micrometer in diameter and in an amount ranging form 0.05% to 0.6% by weight of the skin layer and preferably from 0.1 to 0.3% by weight of the skin layer. The relative thicknesses of the core and surface layers are chosen such that the final surface skin layer thickness after stretching may vary from 1 to 68 microns and preferably from 3 to 25 microns regardless of the final film thickness

The multilayer film may be produced by sequential or simultaneous orientation with a tenter frame process common to the industry and well known in the art. In the particular case of a sequential orientation the following steps are outlined.

The individual layers of the film are produced by melting the polymers individually in separate extruders, adding the particles to the polymer feed to the extruder, and mixing and dispersing in the polymer during the melting of the polymer. The individual layers are filtered to insure melt cleanliness without removing the added particles and combined in a multicavity die. (It should be understood by those skilled in the art that the multilayer melt combination can also be done with a coextrusion feedblock or combined in a coextrusion feedblock and a multicavity die in combination). As the multilayer melt is extruded from the die it is cast directly against a chilled chromed casting roll or alternatively, it may be forced against a chilled chromed casting roll with the use of a pinning mechanism well known in the art such as electrostatic pinning, an air knife, a vacuum box, an additional nip cooling roll or a combination of methods such as an air knife and electrostatic edge pinning. However it is formed, the cast film is cooled by the casting roll to set the molecular structure of the skin and core for subsequent orientation.

On removal from the casting section, the cast sheet is transported to the machine direction orienter at a uniform speed where it is contacted with a series of heated rolls and reheated to the drawing temperature. The heated sheet is then passed between two rolls, the second of which is driven at a speed higher than the first, to stretch the film in the axial or machine direction. This machine direction stretching speed ratio (MDX) may range from 2 to 6 times and preferably from 2.5 to 4 times. The MD stretched film is then cooled after stretching on additional heat transfer rolls and transferred to a tenter for transverse (TD) orientation.

The TD orientation is accomplished by stretching in a heated oven consisting of preheat, stretching and annealing sections. The stretching is performed between two continuous rails in which travel a continuous chain with clips designed for gripping the edges of the MD stretched sheet. In the preheat section the rails are approximately parallel and at the approximate width of the MD stretched sheet. The rails then diverge forcing the chains apart and stretching the film restrained in the clips. This TD stretching can be from 2 times to 6 times the initial width of the chain separation and preferably from 2.5 to 4 times. The rails are then made parallel at the end of the stretching section at the final width and the film is heated at a temperature suitable for crystallizing and annealing the film while restrained in the clips. This crystallization and annealing will reduce the shrinkage of the film when reheated and the conditions chosen to give the desired shrinkage of the film in subsequent converting operations. If desired the chain separation may be reduced slightly to improve the dimensional stability of the film as is well known in the art. The rails then exit the oven and the film is quenched in air before being released from the clips.

Upon release, the stretched film is passed to a thickness scanning station to measure the thickness uniformity of the film. Die adjustments either in a manual or automatic mode may be made to improve the uniformity of the thickness as required or desired. The stretched film then has its edges slit off to remove the remaining thick regions where it was held by the clips and the trim is then ground for reuse. If desired, the ground trim may be added directly back into the film making process or pelletized in a separate operation and added back into the film making process or resold for other purposes. The film is then passed thru a web handling system and may be subjected to a surface treatment step on one or both sides and is then alternatively wound up on master or mill rolls for subsequent slitting, or may be cut into various sized sheeting and stacked for use in various converting processes.

The 4 to 30 mil films and sheets produced show an unexpected folding and crease retention behavior which makes the product especially desirable for die cutting and folding into high clarity containers and other products such as presentation cards including gift cards and certificates. The folded containers may have a reclosable lid due to the excellent fold flex durability. The films also show an excellent haze and gloss values and display a low and uniform COF off the line and do not require additional time or temperature to reduce the COF.

It should be obvious that the folding behavior and slip modification technology can be applied to films with additional intermediate layers between the core and skins which are, clear, dyed or pigmented, to create colored films or to add desirable decorative effects to the film.

The following examples are an illustration of the present invention, but the invention is not limited to the specific examples.

### EXAMPLE 1

An 8 mil, three layer film was produced by individually extruding a major or inner layer (core) of PLA4042 and onto this core extruding two additional unmodified surface layers of PLA4042. The final skin thickness after stretching was approximately 2.5 mils. The three polymer flows were combined in a three cavity die and cast onto a cooled chill roll. The sheet so produced was transferred to a machine direction orienter (MDO) and reheated on hot rollers set at from 550-70° C. and preferably at 600-62° C. The sheet was then stretched between two rollers driven at different speeds with a speed increase of approximately 3 times between the first and second rolls. The drawn sheet was then passed over a series of cooling rollers and transferred to a tenter frame for transverse stretching where it was introduced into a set of clips located on parallel chains traveling at a uniform speed with a uniform spacing and preheated in a forced air oven at a temperature of 50°-65° C. Next the film was stretched 3 times in the transverse (TD) direction by a divergence of the chains in the oven at a temperature of 65°-75° C. and then annealed and crystallized in a section of parallel or slightly converging chain separation at approximately 135° to 145° C. and preferably at 141° C. to heat set the film and increase it crystallinity and reduce its tendency to shrink on reheating. Next the film was released from the clips and transferred to a film gauging system to determine its thickness uniformity and then the thickened edges remaining for the clips were slit and removed. The film next passed through a surface treatment station and was treated to a desired level to improve film processing and conversion and wound into master rolls for subsequent slitting operations. The 8-10 mil film or sheet) produced show a highly desirable folding and crease retention behavior which makes the product especially suitable for die cutting and folding into high clarity containers. The folded containers may have a reclosable lid due to the excellent fold flex durability. The film produced also showed an excellent optical clarity and a surprisingly low tendency towards scuffing and dust pick up.

### EXAMPLE 2

An 8 mil, three layer film was produced by individually extruding a major or inner layer (core) of PLA4042 and onto this core extruding two additional surface layers of PLA4042 each containing 0.2% by weight of the skin layer of a spherical particle produced from crosslinked polymethylsilsesquioxane. The average particle size was 2 micrometers (Tospearl 120A) and the final skin thickness after stretching was from 0.8 to 1.5 microns. The three polymer flows were combined in a three cavity die and cast onto a cooled chill roll. The sheet so produced was transferred to a machine direction orienter (MDO) and reheated on hot rollers set at from 550-70° C. and preferably at 600-62° C. The sheet was then stretched between two rollers driven at different speeds with a speed increase of approximately 3 times between the first and second rolls. The drawn sheet was then passed over a series of cooling rollers and transferred to a tenter frame for transverse stretching where it was introduced into a set of clips located on parallel chains traveling at a uniform speed with a uniform spacing and preheated in a forced air oven at a temperature of 500-65° C. Next the film was stretched 3 times in the transverse (TD) direction by a divergence of the chains in the oven at a temperature of 65°-75° C. and then annealed and crystallized in a section of parallel or slightly converging chain separation at approximately 135° to 145° C. and preferably at 141° C. to heat set the film and increase it crystallinity and reduce its tendency to shrink on reheating. Next the film was released from the clips and transferred to a film gauging system to determine its thickness uniformity and then the thickened edges remaining for the clips were slit and removed. The film next passed through a surface treatment station and was treated to a desired level to improve film processing and conversion and wound into master rolls for subsequent slitting operations. The 4 to 25 mil films and sheets produced show a highly desirable folding and crease retention behavior which makes the product especially suitable for die cutting and folding into high clarity containers. The folded containers may have a reclosable lid due to the excellent fold flex durability. The film produced also showed excellent handling in sheeting and winding operations while maintaining an excellent optical clarity and a surprisingly low tendency towards scuffing and static generation and dust pick up.

### EXAMPLE 3

The film was prepared as in example 2 with the exception that the antiblock particle was comprised of from 0.05-2.5% by weight of the skin layer of a silica particle of 4-5 micron average particle size. The 4 to 25 mil films and sheets produced show a highly desirable folding and crease retention behavior which makes the product especially suitable for die cutting and folding into high clarity containers. The folded containers may have a reclosable lid due to the excellent fold flex durability. The film produced also showed excellent handling in sheeting and winding operations but displayed a poor clarity evidenced by a increased and objectionable haze level. There was no improvement in reducing static generation and in reduced dust pick up.

### EXAMPLE 4

The film was produced as in example 2 where both surface layers were comprised of a heat sealable PLA 4060 copolymer and containing 0.2% by weight of the skin layer of a 4.5 micrometer diameter spherical particle produced from crosslinked polymethylsilsesquioxane. The 4 to 25 mil films and sheets produced show a highly desirable folding and crease retention behavior which makes the product especially suitable for die cutting and folding into high clarity containers. The folded containers may have a reclosable lid due to the excellent fold flex durability. The film produced also exhibited improved heat sealing, excellent handling in sheeting and winding operations while maintaining an excellent optical clarity and a surprisingly low tendency towards scuffing and static generation and dust pick up. The film also has displayed good hot slip and printability

### EXAMPLE 5

The film of example 1 was die cut and folded and sealed together along an extended edge flap to produce a box with an operable hinged flap

### EXAMPLE 6

The film of example 1 or 2 was die cut and folded and glued, or ultrasonically or solvent welded together along an extended edge flap to produce a box with an operable hinged flap

### EXAMPLE 7

The film of example 1 was cut and rolled and edge sealed together to produce a tube suitable for the display of products when supplied with end caps or similar closures suitable for tubular packaging.

### EXAMPLE 8

The film of Example 1 was thermoformed into a hinged clam shell folding container with various closure options generally known to those skilled in the art

### EXAMPLE 9

The film of example 4 was thermoformed into a hinged clam shell or folding container for the purpose of holding and displaying packaged items which is heat, ultrasonically or solvent welded together along its edges or at discreet points to prevent casual opening of the package

### EXAMPLE 10

The film of example 1 was thermoformed into a hinged clam shell or folding container for the purpose of holding and displaying packaged items which is ultrasonically or solvent welded together along its edges or at discreet points to prevent casual opening of the package

### EXAMPLE 11

The film of example 4 was die cut and folded and sealed together along an extended edge flap to produce a box with an operable hinged flap

### EXAMPLE 12

The film of example 4 was cut and rolled and edge sealed together to produce a tube suitable for the display of products when supplied with end caps or similar closures suitable for tubular packaging.

Various modifications to the process and film construction will be apparent to and can be readily made by those skilled in the art without departing from the scope and spirit of this invention. Accordingly, it is not intended the scope of the claims appended hereto be limited to the description as set forth herein, but rather that the claims be broadly construed.

What is claimed is:

1. A composite film of from 4 to 30 mils thickness comprising, an inner layer of polylactic acid with a first and second surface and attached to one or both of said first and second inner layer surfaces one or more additional skin layers of the same or different polylactic acid resins as the inner layer.

2. The film of claim 1 wherein the skin layers containi spherical particles for the purpose of reducing the coefficient of friction (COF) of the composite film.

3. The film of claim 1 or 2 where the polylactic acid skin layers are of the same polymer as the inner layer.

4. The film of claim 3 where the polylactic acid is a high crystallinity polymer.

5. The film of claim 1 or 2 where the skin layers are of a lower melting polylactic acid composition than the inner layer.

6. The film of claim 1 or 2 where the skin layers are of a lower crystallinity than the inner layer.

7. The film of claim 1 or 2 where one skin layer is of a different polylactic acid composition.

8. The film of claim 2 where one skin layer does not contain the spherical particles.

9. The film of claim 2 where the spherical particles are a crosslinked polymethylsilsesquioxane particles.

10. The film of claim 2 where the spherical particles are a crosslinked acrylic resin particles.

11. The film of claim 2 where the spherical particles are composed of a polymeric substance.

12. The film of claim 2 where the spherical particles are present in a range of from 0.01% to 0.5% (100 to 5000 ppm) by weight of the skin polymer.

13. The film of claim 1 or 2 where one or both surfaces are subjected to corona, flame or plasma treatment.

14. The film of claim 1 or 2 where at least one intermediate PLA layer is added between the core and outer skin layers.

15. The film of claim 1 where intermediate PLA layers are attached to the first surface and second surface of the inner core layer and located between the core and skin layers.

16. The film of claim 14 where at least one of the intermediate layers are colored with a transparent dye.

17. The film of claims 1 or 14 where the inner core layer is colored with a transparent dye.

18. The film of claims 1 or 14 where at least one of the skin layers are colored with a transparent dye.

19. A boxlike container produced, from film according to claim 1, by folding or creasing combined with sealing or gluing along at least one edge or between two surfaces to create a sealed container.

20. A boxlike container produced from film according to claim 1, by folding or creasing and sealing or gluing along an edge with a folding and reclosable flap on at least one surface of the boxlike container for the purpose of gaining access to the interior of the package.

21. A folding thermoformed container from film according to claim 1, with a hinged fold for repetitive opening and closing of the container in conjunction with a means for sealing or holding the container in a closed configuration.

22. A tubular container produced by die cutting a rectangular form, from film according to claim 1 with two attached circular appendages with cut and formed edge tabs which are folded and inserted into a tube formed from the rolled and edged sealed rectangular form.

23. A tubular container produced from film according to claim 1, by the combination of a rolled, edged joined tube combined with two circular die cut forms with integral edge tabs cut and folded and then glued, sealed or welded to the inner (or outer) surface of the formed tube to create a cylindrical container.

24. A method for the production of biodegradable multilayer polylactic acid films comprising the steps of: coextruding a multilayer sheet, biaxially orienting the extruded sheet, surface treating the film and winding into a master roll.

25. The method of claim 24 wherein the outer layers are modified by the incorporation of crosslinked spherical particles.

26. A method for the production of biodegradable multilayer polylactic acid films comprising the steps of: coextruding a multilayer sheet, biaxially orienting the extruded sheet, surface treating the film and cutting the film into discreet sized sheet and stacking.

27. The method of claim 27 wherein the outer layers are modified by the incorporation of crosslinked spherical particles.
